(19) United States
(12) Patent Application Publication
(10) Pub. No.: US 2022/0207261 A1
(43) Pub. Date: Jun. 30, 2022

(54) METHOD AND APPARATUS FOR DETECTING ASSOCIATED OBJECTS

(71) Applicant: SENSETIME INTERNATIONAL PTE. LTD., Singapore (SG)

(72) Inventors: Xuesen ZHANG, Singapore (SG); Bairun WANG, Singapore (SG); Chunya LIU, Singapore (SG); Jinghuan CHEN, Singapore (SG)

(21) Appl. No.: 17/345,469

(22) Filed: Jun. 11, 2021

Related U.S. Application Data
(63) Continuation of application No. PCT/IB2021/053488, filed on Apr. 28, 2021.

(30) Foreign Application Priority Data
Dec. 29, 2020 (SG) 10202013169Q

(51) Int. Cl. G06K 9/00; G06T 7/00

(52) U.S. Cl. CPC G06K 9/00268; G06T 7/0014; G06T 2207/30201; G06T 2207/20084; G06K 9/00288

(57) ABSTRACT

Methods, apparatuses, systems, devices, and computer-readable storage media for detecting associated objects are provided. In one aspect, a method includes: detecting at least one matching object group from an image to be detected, each of the at least one matching object group including at least two target objects; and, for each of the at least one matching object group, acquiring visual information of each of the at least two target objects in the matching object group and spatial information of the at least two target objects in the matching object group, and determining whether the at least two target objects in the matching object group are associated, according to the visual information and the spatial information of the at least two target objects in the matching object group.

### CROSS-REFERENCE TO RELATED APPLICATIONS

The present disclosure is a continuation application of International Application No. PCT/IB2021/053488 filed on Apr. 28, 2021, which claims a priority of the Singaporean patent application No. 10202013169Q filed on Dec. 29, 2020, all of which are incorporated herein by reference in their entireties.

### TECHNICAL FIELD

The present disclosure relates to the field of computer vision technology, and in particular, to a method and apparatus for detecting associated objects.

### BACKGROUND

Target detection, such as detection of human bodies, faces, etc. in video frames or scene images, is an important part of intelligent video analysis. In the related art, a target detector such as a Faster RCNN (Region-CNN, Region Convolutional Neural Network) may be used to acquire target detection boxes in the video frames or scene images to implement the target detection.

However, in dense scenes, different targets may occlude each other. Taking a scene with relatively dense crowds of people as an example, body parts may be occluded between different people. In this case, the target detector is difficult to meet detection requirements in high-precision scenes.

### SUMMARY

Embodiments of the present disclosure provide a method and apparatus for detecting associated objects, an electronic device, and a storage medium.

In a first aspect, embodiments of the present disclosure provide a method of detecting associated objects, including: detecting at least one matching object group from an image to be detected, where each of the at least one matching object group includes at least two target objects; acquiring visual information of each of the at least two target objects in each matching object group, and spatial information of the at least two target objects in each matching object group; and determining whether the at least two target objects in each matching object group are associated, according to the visual information and the spatial information of the at least two target objects in each matching object group.

In a second aspect, embodiments of the present disclosure provide an apparatus for detecting associated objects, including: a detection module, configured to detect at least one matching object group from an image to be detected, where each of the at least one matching object group includes at least two target objects; an acquisition module, configured to acquire visual information of each of the at least two target objects in each matching object group, and spatial information of the at least two target objects in each matching object group; and a determination module, configured to determine whether the at least two target objects in each matching object group are associated, according to the visual information and the spatial information of the at least two target objects in each matching object group.

In a third aspect, embodiments of the present disclosure provide an electronic device, including: a processor; and a memory communicatively connected with the processor and storing computer instructions readable by the processor, where the computer instructions, when read by the processor, cause the processor to perform the method of any one of the embodiments in the first aspect.

In a fourth aspect, embodiments of the present disclosure provide a storage medium, storing computer-readable instructions, where the computer-readable instructions are configured to cause a computer to perform the method of any one of the embodiments in the first aspect.

In a fifth aspect, embodiments of the present disclosure provide a computer program, including computer-readable codes which, when executed in an electronic device, cause a processor in the electronic device to perform the method of any one of the embodiments in the first aspect.

The method of detecting associated objects according to embodiments of the present disclosure includes: detecting at least one matching object group from an image to be detected, where each matching object group includes at least two target objects; acquiring visual information of each target object in each matching object group, and spatial information of the at least two target objects in each matching object group; and determining whether the target objects in each matching object group are associated target objects, according to the visual information and the spatial information. Using association features of target objects in a same matching object group to assist in target detection, it is possible to improve the accuracy of target detection in complex scenes. For example, human detection in multi-person scenes can be implemented through face-and-body association detection, thereby improving detection accuracy. In addition, by combining the visual information and the spatial information of the target objects during association detection, the accuracy of the association detection of the target objects can be improved. For example, during the face-and-body association detection, not only visual feature information of the face and the body are used, but also spatial position feature information between the face and the body is further considered. Using the spatial position feature to assist in face-and-body association, it is possible to improve the accuracy of the face-and-body association, thereby improving the accuracy of target detection.

### BRIEF DESCRIPTION OF DRAWINGS

In order to illustrate the technical solutions in the detailed description of the present disclosure more clearly, the accompanying drawings used in the detailed description will be briefly introduced below. Obviously, the drawings in the following description illustrate some embodiments of the present disclosure. For those ordinary skilled in the art, other drawings may also be obtained from these drawings without any creative efforts.

FIG. 1 is a flowchart of a method of detecting associated objects according to some embodiments of the present disclosure.

FIG. 2 is a flowchart of a method of detecting matching object groups according to some embodiments of the present disclosure.

FIG. 3 is a flowchart of a method of extracting visual information according to some embodiments of the present disclosure.

FIG. 4 is a schematic structural diagram of a detection network according to some embodiments of the present disclosure.

FIG. 5 is a schematic diagram of a principle of a method of detecting associated objects according to some embodiments of the present disclosure.

FIG. 6 is a schematic diagram of an association detection network according to some embodiments of the present disclosure.

FIG. 7 is a flowchart of a method of determining whether target objects in a matching object group are associated according to some embodiments of the present disclosure.

FIG. 8 is a schematic diagram of visual output of a detection result of associated objects according to some embodiments of the present disclosure.

FIG. 9 is a schematic diagram of a training process of a neural network for detecting associated objects according to some embodiments of the present disclosure.

FIG. 10 is a structural block diagram of an apparatus for detecting associated objects according to some embodiments of the present disclosure.

FIG. 11 is a structural block diagram of a detection module in an apparatus for detecting associated objects according to some embodiments of the present disclosure.

FIG. 12 is a structural block diagram of a determination module in an apparatus for detecting associated objects according to some embodiments of the present disclosure.

FIG. 13 is a structural diagram of a computer system suitable for implementing a method of detecting associated objects according to the present disclosure.

### DETAILED DESCRIPTION

Hereinafter, the technical solutions of the present disclosure will be described clearly and completely in conjunction with the accompanying drawings. Apparently, the described embodiments are part of the embodiments of the present disclosure, rather than all of the embodiments. Based on the embodiments of the present disclosure, all other embodiments obtained by those ordinary skilled in the art without any creative efforts belong to the protection scope of the present disclosure. Moreover, the technical features involved in different embodiments of the present disclosure described below may be combined with each other without any conflict therebetween.

Associated object detection has important research significance for intelligent video analysis. Taking human detection as an example, in a complex scene with a large number of people, people may occlude each other. If a method for detecting a single human is performed, a false detection rate is relatively high and it is difficult to meet the requirements. The associated object detection may use “face-and-body association” to determine matching object groups, and the detection of target objects, i.e., face and body, can be implemented by determining whether the face and the body in the same matching object group belong to the same person, which can improve the accuracy of target detection in complex scenes.

A target detector such as a Faster RCNN (Region-CNN, Region Convolutional Neural Network) may be used in target object detection to acquire detection boxes for faces and bodies in video frames or scene images, and then a classifier is trained according to visual features of the faces and the bodies and may be used to obtain a predicted association result. The accuracy of association detection in similar methods is relatively limited. For a high-precision detection scene such as a multiplayer game scene, not only people in the scene are often partially occluded, but also it is necessary to determine whether a face, a body and a hand of a user and even game props are associated, so as to know which user made the relevant action. Once the association fails, it may even cause significant losses. Therefore, the accuracy of association detection in the related art is difficult to meet the requirements in high-precision scenes.

Embodiments of the present disclosure provide a method and apparatus for detecting associated objects, an electronic device, and a storage medium, thereby improving the detection accuracy of the associated objects.

In a first aspect, embodiments of the present disclosure provide a method of detecting associated objects. An execution subject of the method according to the embodiments of the present disclosure may be a terminal device, a server, or other processor devices. For example, the terminal device may include a user equipment, a mobile device, a user terminal, a cellular phone, a vehicle-mounted device, a personal digital assistant, a handheld device, a computing device, a wearable device, etc. In some embodiments, the method may also be implemented by a processor calling computer-readable instructions stored in a memory, which is not limited in the present disclosure.

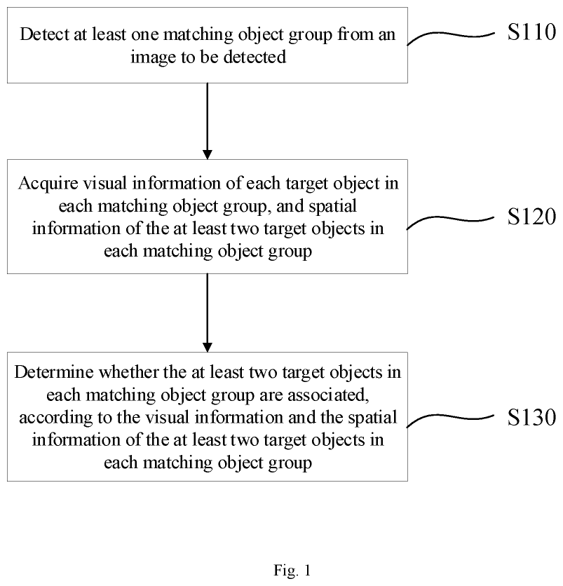

FIG. 1 shows a method of detecting associated objects according to some embodiments of the present disclosure. The method according to the present disclosure will be described below in conjunction with FIG. 1.

As shown in FIG. 1, in some embodiments, the method of detecting associated objects according to the present disclosure includes steps S110-S130.

At step S110, at least one matching object group is detected from an image to be detected, where each matching object group includes at least two target objects.

Specifically, the image to be detected may be a natural scene image, and preset associated target objects are expected to be detected from the image. It may be understood that the “associated target objects” mentioned in the present disclosure refer to two or more target objects that are associated with one another in a scene of concern. For example, taking the face-and-body association in the human detection as an example, the image to be detected includes a plurality of faces and a plurality of bodies, and the “face” and the “body” belonging to the same person may be referred to as “associated target objects”. For another example, in a multi-person horse-riding entertainment scene, the image to be detected includes a plurality of humans and a plurality of horses, and the “human” and the “horse” having a riding relationship may be referred to as “associated target objects”, which can be understood by those skilled in the art, and will not be illustrated herein.

The image to be detected may be captured by an image capturing device such as a camera. Specifically, the image to be detected may be a single-frame image captured by the image capturing device, or may include frame images in a video stream captured by the image capturing device, which is not limited in the present disclosure.

In the embodiments of the present disclosure, the at least one matching object group may be detected from the image to be detected, and each matching object group may include at least two target objects. The matching object group refers to a set of at least two target objects that need to be confirmed to be associated or not.

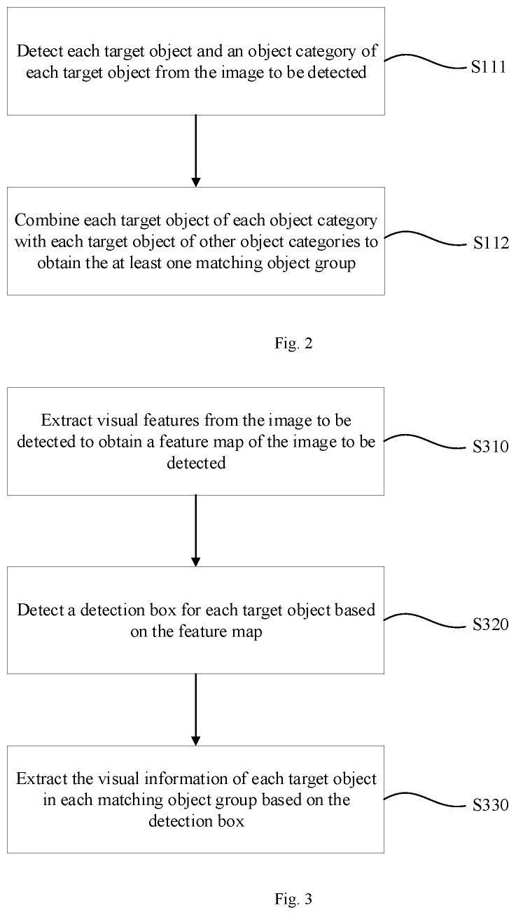

As shown in FIG. 2, in some embodiments, detecting the at least one matching object group from the image to be detected may include steps S111 and S112.

At step S111, each target object and an object category of each target object may be detected from the image to be detected.

At step S112, each target object of each object category may be combined with each target object of other object categories to obtain the at least one matching object group.

In an example, taking the “face-and-body” association detection as an example, a plurality of target objects and the object category of each target object may be detected from the image to be detected. The object category includes “face” category and “body” category, target objects of the “face” category may include m faces, and target objects of the “body” category may include n bodies. Each of the m faces may be combined in pairs with the n bodies respectively to obtain a total of m*n face-and-body pairs. The “face” and the “body” are the target objects detected, and the m*n “face-and-body pairs” obtained by combining the faces in pairs with the bodies are the matching object groups, where m and n are positive integers.

In another example, in the multiplayer game scene, each person may be provided with an associated object, such as a horse in the horse-riding entertainment scene, game props in a table game scene, etc. The method according to the present disclosure can also be applied to “human-and-object” association detection. Taking the horse-riding entertainment scene as an example, a plurality of target objects and the object category of each target object may be detected from the image to be detected. The object category includes “human” category and “object” category. Target objects of the “human” category may include p humans, and target objects of the “object” category may include q horses. Each of the p humans may be combined in pairs with the q horses respectively to obtain a total of p*q human-and-object pairs. The “human” and the “object” are the target objects detected, and the p*q “human-and-object pairs” obtained by combining the humans in pairs with the horses are the matching object groups, where p and q are positive integers.

In yet another example, “hand-and-face-and-body” association detection is taken as an example. A plurality of target objects and the object category of each target object may be detected from the image to be detected. The object category includes “hand” category, “face” category and “body” category, and each object category includes at least one target object belonging to this category. A plurality of “hand-and-face-and-body” groups obtained by combining each target object of each object category with the target objects of the other two object categories respectively, that is, by combining one of the hands, one of the faces, and one of the bodies, are the matching object groups. For example, target objects of the “hand” category may include k hands, target objects of the “face” category may include m faces, and target objects of the “body” category may include n bodies. Each of the k hands may be combined with the m faces and the n bodies respectively to obtain a total of k*m*n hand-and-face-and-body groups, where k, m and n are positive integers.

As can be understood from the above examples, in the embodiments of the present disclosure, there is no limit to the number of the target objects in the matching object group, and/or the categories of the target objects. The matching object group may include at least two target objects, for example, two, three, four or more target objects. The target object may include a human body or various parts of the human body, and may also include an object associated or unassociated with the human body in a scene, which is not limited in the present disclosure.

In an example, the image to be detected may be processed through an association detection network to obtain the at least one matching object group from the image to be detected, which will be described in detail below.

At step S120, visual information of each target object in each matching object group, and spatial information of the at least two target objects in each matching object group are acquired.

Specifically, the visual information refers to visual feature information of each target object in the image, which is generally an image feature obtained according to a pixel value of the image. For example, visual features may be extracted from the image to be detected, to obtain image feature information of a face, hand, body, or object in the image. The spatial information may include spatial position feature information of target objects in a matching object group and/or posture information of target objects in a matching object group. Alternatively, the spatial information may include spatial position relationship information or relative posture information between respective target objects in a matching object group, for example, the relative spatial position feature information and/or relative orientation information between the face and the body, the face and the hand, the human and the object, etc. in the image.

In an example, visual features may be extracted from a region where each target object is located in the image to be detected, for example, feature points may be extracted from the region, and pixel values of the feature points may be converted into visual features of the target object. Position feature information of each target object may be generated based on a position of a boundary of the target object in the image, and a posture of each target object may be analyzed according to a standard posture model for the target object to obtain the posture information of the target object, thereby obtaining the spatial information of the target object. Alternatively, a relative position and/or relative posture between the respective target objects in the matching object group may be analyzed, and the spatial information obtained thereby may also include relative position information and/or relative posture information of each target object with respect to other target objects.

In an example, during processing of the image to be detected, a feature map may be obtained by extracting visual features from the image to be detected through an object detection network firstly, and then the visual information of each target object may be extracted based on the feature map.

In an example, during processing of the image to be detected, the image to be detected may be processed through an association detection network to obtain the spatial information of the at least two target objects in each matching object group.

Structures and implementation principles of the networks in the above examples will be described in detail below.

At step S130, whether the at least two target objects in each matching object group are associated is determined, according to the visual information and the spatial information of the at least two target objects in each matching object group.

For a certain matching object group such as a face-and-body matching object group, it is intended to determine whether the face and the body in the matching object group are associated, that is, whether the face and the body belong to the same person. The visual information and the spatial information of the at least two target objects in the matching object group, after obtained, may be combined to determine whether the at least two target objects in the matching object group are associated.

It is worth noting that, at least one inventive concept of the method according to the present disclosure is combining the spatial information of the target objects in the matching object group based on the visual information to determine the association between the target objects. Taking the face-and-body association detection as an example, a position distribution of the face on the body is often fixed. Therefore, on the basis of considering the visual information of the face and the body, the spatial position information of the face and the body is combined to assist in the association, which may have a better robustness when dealing with occlusion problems in complex scenes with multiple people, and may improve the accuracy of the face-and-body association.

In addition, it may be understood that, based on the above inventive concept, the associated target objects in the method according to the present disclosure refer to objects that may be associated with one another in a spatial position, so that high-reliability spatial information may be extracted from the image to be detected. There is no limit to the number and categories of the target objects in the matching object group, and the target objects may include human body parts, animals, props, and any other objects that may be associated with one another in the spatial position, which will not be repeated herein.

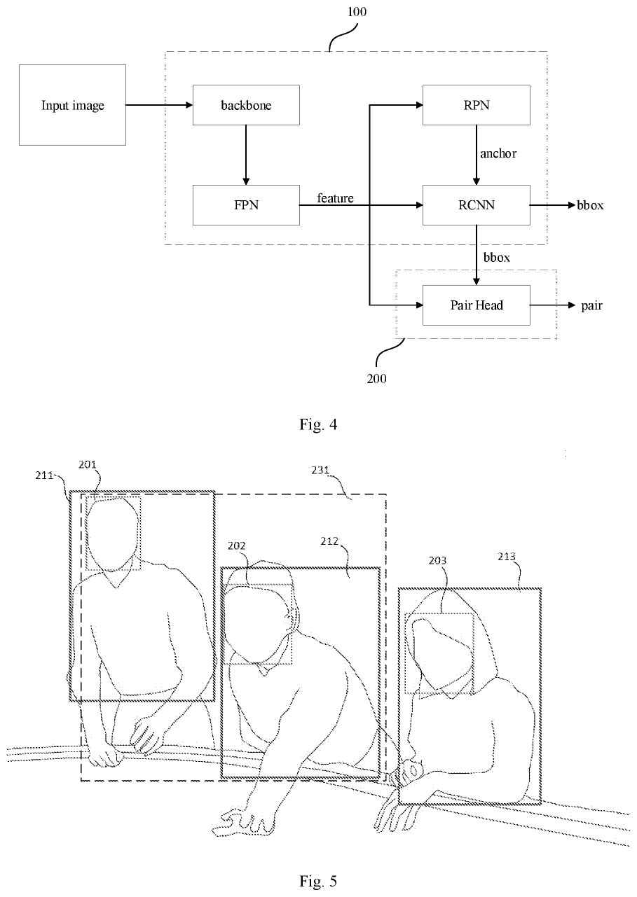

In an example, the visual information and the spatial information of the at least two target objects in each matching object group may be fused through the association detection network (for example, “Pair Head” in FIG. 4), and an association classification processing may be performed based on fusion features, to determine whether the at least two target objects in a certain matching object group are associated, which will be described in detail below.

As above, the method of detecting associated objects according to the present disclosure uses association features of target objects in a same matching object group to assist in target detection, to improve the accuracy of target detection in complex scenes. For example, human detection in multi-person scenes can be implemented through the face-and-body association detection, thereby improving detection accuracy. In addition, by combining the visual information and the spatial information of the target objects during association detection, the accuracy of the association detection of the target objects can be improved. For example, during the face-and-body association detection, not only visual feature information of the face and the body are used, but also spatial position feature information between the face and the body is further considered. By using the spatial position feature to assist in face-and-body association, it is possible to improve the accuracy of the face-and-body association, thereby improving the accuracy of target detection.

In some embodiments, visual feature extraction may be performed on each target object in the matching object group to obtain the visual information of the target object.

Specifically, FIG. 3 shows a process of performing the visual information extraction on the target object, and FIG. 4 shows an architecture of a detection network for the method according to the present disclosure. The method according to the present disclosure will be further described below in conjunction with FIG. 3 and FIG. 4.

As shown in FIG. 3, in some embodiments, the method of detecting associated objects may include steps S310-S330.

At step S310, visual features may be extracted from the image to be detected to obtain a feature map of the image to be detected.

Specifically, as shown in FIG. 4, a detection network according to the present disclosure includes an object detection network 100 and an association detection network 200. The object detection network 100 may be a trained neural network that is configured to perform visual feature extraction on the target objects in the image to be detected to obtain the visual information of the target objects.

In this embodiment, the object detection network 100 may include a backbone network and a FPN (Feature Pyramid Network). The image to be detected may be processed through the backbone network and the FPN in turn to obtain the feature map of the image to be detected.

In an example, the backbone network may use, for example, VGGNet, ResNet, etc. The FPN may convert the feature map obtained from the backbone network into a feature map with a multi-layer pyramid structure. The backbone network is a part configured to extract image features. The FPN is configured to perform a feature enhancement processing, which may enhance shallow features extracted by the backbone network. It may be understood that the foregoing networks are merely examples and are not intended to limit the present disclosure. For example, in other embodiments, the backbone network may use any other form of feature extraction network; for another example, in other embodiments, the FPN in FIG. 4 may not be used, but the feature map extracted by the backbone network may be directly used as the feature map of the image to be detected; etc., which are not limited in the present disclosure.

At step S320, a detection box for each target object may be detected based on the feature map.

At step S330, the visual information of each target object in each matching object group may be extracted based on the detection box.

Specifically, with continued reference to FIG. 4, the object detection network 100 may also include an RPN (Region Proposal Network). After the feature map of the image to be detected is obtained, the RPN may predict the detection box (or anchor box) for each target object and the object category of the target object based on the feature map output from the FPN. For example, for the face-and-body association detection, the RPN may calculate the detection boxes for the face and the body in the image to be detected, and the “face” or “body” category to which the target object in the detection box belongs, based on the feature map.

In this embodiment, the object detection network 100 may also include an RCNN (Region Convolutional Neural Network). The RCNN may calculate a bounding box (hereinafter referred to as “bbox”) offset for the detection box for each target object based on the feature map, and perform a boundary regression processing on the detection box for the target object according to the bbox offset, to obtain a more accurate detection box for the target object.

After the detection box for each target object is obtained, the visual feature information of each target object may be extracted based on the feature map and each detection box. For example, further feature extraction may be performed on each detection box according to the feature map, to obtain feature information of each detection box as the visual feature information of the corresponding target object. Alternatively, the feature map and each detection box may be input to a visual feature extraction network, to obtain the visual feature information of each detection box, that is, to obtain the visual feature of each target object.

In an example, taking the face-and-body association detection as an example, the input image to be detected is shown in FIG. 5. The RPN and the RCNN may obtain the detection boxes for each face and each body in the image to be detected according to the feature map of the image to be detected. The detection box may be rectangular.

With reference to FIG. 5, the image to be detected includes three human bodies and three human faces in total. After the image is processed through the RPN and the RCNN, three face detection boxes 201, 202 and 203, and three body detection boxes 211, 212 and 213 may be obtained. The visual information of each face and each body may be extracted based on each face detection box and each body detection box.

The association detection network (for example, “Pair Head” in FIG. 4) 200 may also be a trained neural network, which is configured to combine target objects of different categories based on the obtained detection boxes and object categories of the target objects to obtain respective matching object groups. For example, in the face-and-body association detection scene, respective faces and respective bodies may be randomly combined with each other based on the obtained detection boxes and object categories of the faces and the bodies, to obtain respective face-and-body matching object groups. Taking FIG. 5 as an example, these three face detection boxes 201, 202 and 203 are combined in pairs with these three body detection boxes 211, 212 and 213 respectively to obtain a total of nine face-and-body matching object groups. Next, the position feature of each face-and-body matching object group needs to be determined.

For each matching object group, an auxiliary bounding box may be firstly constructed according to the detection box for each target object in the matching object group. Taking the matching object group composed of the face detection box 201 and the body detection box 212 in FIG. 5 as an example, one union box may be firstly determined as the auxiliary bounding box according to these two detection boxes 201 and 212, where the determined union box, that is, the auxiliary bounding box 231 indicated by a dotted line in FIG. 5, contains both of the detection boxes 201 and 212 and has a minimum area.

It is worth noting herein that the constructed auxiliary bounding box aims to calculate the spatial information of each target object in the matching object group subsequently. In this embodiment, auxiliary bounding boxes that cover the detection box for each target object in the matching object group may be selected, such that the spatial information of each target object obtained subsequently may be fused with the spatial information of other target objects in the matching object group to which it belongs, thus the associated object detection may be performed based on a potential spatial position relationship of the actually associated target objects, thereby making the information more compact, reducing interference information in other positions, and reducing the amount of calculation. Furthermore, one of the auxiliary bounding boxes that cover the detection box for each target object in the matching object group which has the minimum area may be selected as the auxiliary bounding box. In other embodiments, the auxiliary bounding box 231 is ensured to cover at least the target objects in the matching object group, which should be understood by those skilled in the art.

After the auxiliary bounding box is obtained, the position feature information of the target objects may be generated according to the detection boxes for the target objects and the auxiliary bounding box. In FIG. 5, face mask information may be generated according to the face detection box 201 and the auxiliary bounding box 231. The face mask information indicates spatial position feature information of the face detection box 201 in the matching object group with respect to the auxiliary bounding box 231. Similarly, body mask information may be generated according to the body detection box 212 and the auxiliary bounding box 231. The body mask information indicates spatial position feature information of the body detection box 212 in the matching object group with respect to the auxiliary bounding box 231.

In an example, when calculating the position feature information of the face and the body, values of pixels in the face detection box 201 and the body detection box 212 may be set to 1, and a value of an initial pixel in the auxiliary bounding box 231 may be set to 0, such that the position feature information of the face and the body with respect to the auxiliary bounding box may be obtained by detecting the pixel value.

After the position feature information of the target objects is obtained, the position feature information of the at least two target objects in the matching object group may be stitched or fused in other ways to obtain the spatial information of the target objects in the matching object group.

The matching object group composed of the face in the face detection box 201 and the body in the body detection box 212 is described above. Position features of other matching object groups may be calculated in the same way by sequentially performing the above processes, which will not be repeated herein.

Taking the matching object group composed of the target objects including the face and the body as an example, the association detection network (for example, “Pair Head” in FIG. 4) may determine whether the target objects are associated according to the visual information and the spatial information of the matching object group, after the visual information and the spatial information are obtained.

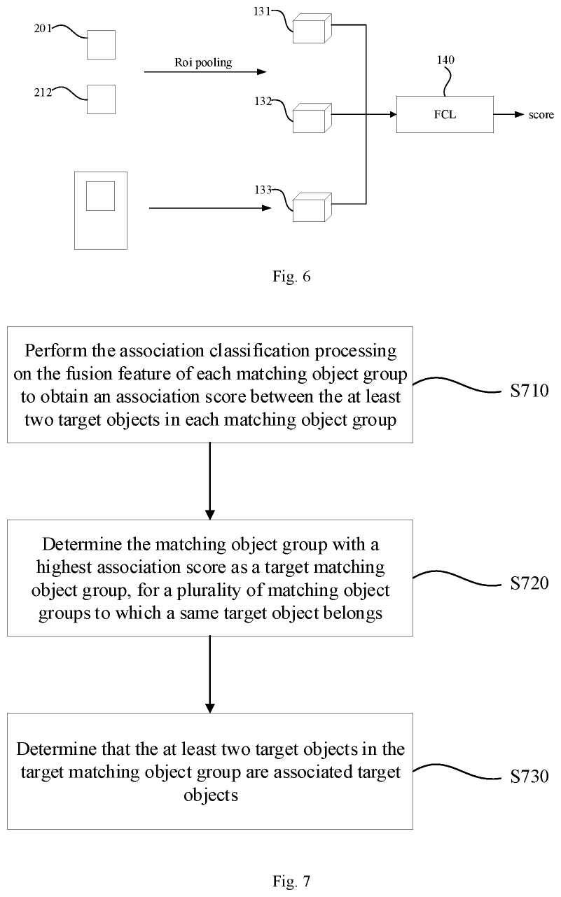

The network structure of the association detection network Pair Head is shown in FIG. 6. A face visual feature 131 and a body visual feature 132 may be obtained respectively after processing the visual information of the face detection box 201 and the body detection box 212 through a Roi (Region of interest) pooling layer, and a spatial feature 133 may be obtained by performing feature conversion on the spatial information. In this embodiment, the face visual feature 131 may be represented by a feature map with a size of 64*7*7, the body visual feature 132 may also be represented by a feature map with a size of 64*7*7, and the spatial feature 133 may be represented by a feature map with a size of 2*7*7.

The face visual feature 131, the body visual feature 132, and the spatial feature 133 may be fused to obtain a fusion feature of the matching object group. Association classification processing may be performed on the fusion feature of each matching object group to determine whether the target objects in the matching object group are associated.

In some embodiments, as shown in FIG. 7, determining whether the target objects in the matching object group are associated may include steps S710-S730.

At step S710, the association classification processing may be performed on the fusion feature of each matching object group to obtain an association score between the at least two target objects in the matching object group.

At step S720, the matching object group with a highest association score may be determined as a target matching object group, for a plurality of matching object groups to which the same target object belongs.

At step S730, it is determined that the at least two target objects in the target matching object group are associated target objects.

Specifically, still taking the network structure shown in FIG. 4 to FIG. 6 as an example for illustration, the fusion feature of each matching object group, after obtained, may pass through a FCL (Fully Connected Layer) 140 which is configured to perform the association classification processing on the fusion feature. The FCL 140 serves as a classifier, which may map the fusion features into scores corresponding to at least two association category labels. Here, the at least two association category labels may include an “associated” label and a “non-associated” label. In this way, the association score between the target objects in each matching object group may be obtained.

For example, as shown in FIG. 5, after the classification processing by the FCL 140, a total of nine predicted scores of the matching object groups may be obtained. For a certain face or body, it belongs to three matching object groups, respectively. For example, for the face 201, it forms three matching object groups with the bodies 211, 212 and 213, respectively. Among these three matching object groups, the matching object group with the highest association score may be selected as the target matching object group. For example, in this example, the matching object group composed of the face 201 and the body 211 has the highest association score, thus this matching object group is regarded as the target matching object group, and the face 201 and the body 211 are determined as the associated target objects, that is, the face 201 and the body 211 belong to the same person.

In addition, in some embodiments, considering visual output of a model, the associated target objects, after determined, may be visually output in the image.

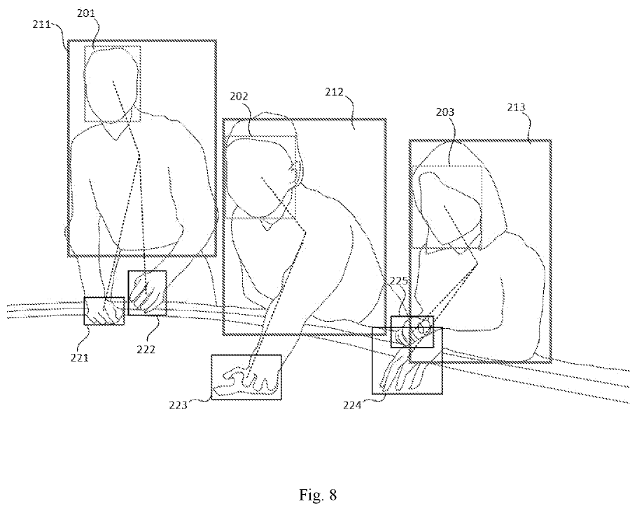

In an example, the visual output of the image may be shown in FIG. 8. In the example of FIG. 8, taking a multiplayer table game scene as an example, the detection of the associated objects includes the association detection of “hand-and-face-and-body”. A plurality of “hand-and-face-and-body” target matching object groups may be obtained through the above embodiments. For the target matching object group, reference may be made to the foregoing, which will not be repeated herein.

After the target matching object groups are obtained, the face detection boxes, the body detection boxes, and the hand detection boxes included in the target matching object groups may be displayed in the image. For example, FIG. 8 includes three face detection boxes 201, 202 and 203, three body detection boxes 211, 212 and 213, and five hand detection boxes 221, 222, 223, 224 and 225. In an example, although FIG. 8 is a gray scale image in which colors cannot be clearly shown, detection boxes of different categories may be shown in different colors, which may be understood by those skilled in the art and will not be described in detail herein.

For the associated target objects in the same target matching object group, the associated target objects may be connected using lines for display. For example, in the example of FIG. 8, in the same target matching object group, a center point of the hand detection box and a center point of the face detection box may both be connected with a center point of the body detection box using dotted lines, which may clearly indicate the associated target objects in the image, thereby having an intuitive visualization effect.

In some embodiments, the visual information and the spatial information of the matching object group, before feature-fused, may also be processed through a FCL for dimensionality reduction processing to map the features into fixed-length features, and then fused, which will not be described in detail herein.

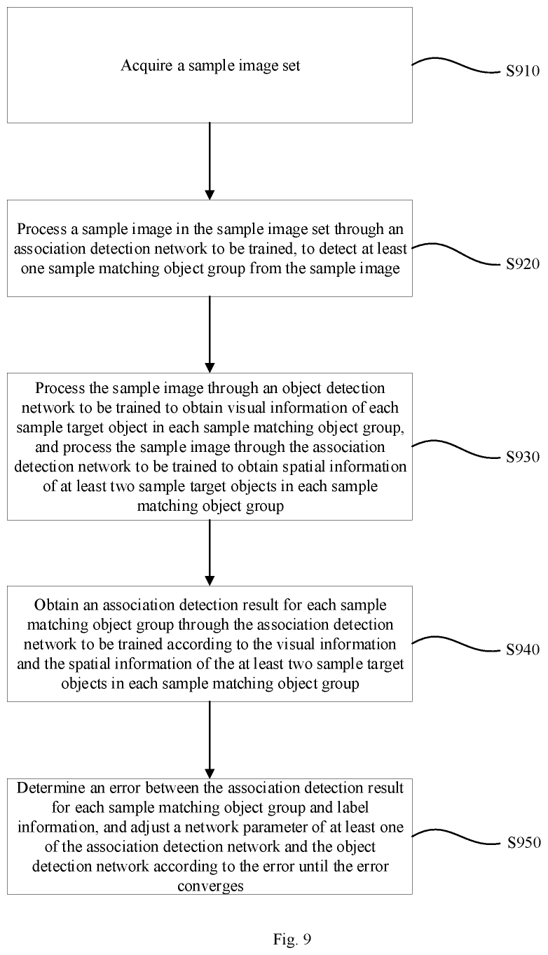

In some embodiments, the method according to the present disclosure may further include a training process of the neural network shown in FIG. 4, which is shown in FIG. 9. The training process of the neural network will be described below in conjunction with FIG. 4 and FIG. 9.

At step S910, a sample image set may be acquired.

At step S920, a sample image in the sample image set may be processed through an association detection network to be trained, to detect at least one sample matching object group from the sample image.

At step S930, the sample image may be processed through an object detection network to be trained to obtain visual information of each sample target object in each sample matching object group, and the sample image may be processed through the association detection network to be trained to obtain spatial information of at least two sample target objects in each sample matching object group.

At step S940, an association detection result for each sample matching object group may be obtained through the association detection network to be trained according to the visual information and the spatial information of the at least two sample target objects in each sample matching object group.

At step S950, an error between the association detection result for each sample matching object group and label information may be determined, and a network parameter of at least one of the association detection network and the object detection network may be adjusted according to the error until the error converges.

Specifically, the sample image set may include at least one sample image. Each sample image may include at least one detectable sample matching object group, such as at least one “face-and-body pair”, “face-and-hand pair”, “human-and-object pair”, “hand-and-face-and-body group”. Each sample matching object group may include at least two sample target objects, which may correspond to least two object categories. The sample target objects may include faces, hands, bodies, humans, objects or the like, and the corresponding object categories may include face category, hand category, body category, human category, object category or the like. In addition, the sample image may also include the label information of each sample matching object group. The label information, as a true value of the sample matching object group, may represent actual association for respective sample target objects in the sample matching object group, to indicate whether the sample target objects in the sample matching object group are actually associated target objects. The label information may be obtained through manual labeling, neural network labeling, etc.

The sample image set may be input into the network shown in FIG. 4, and pass through a to-be-trained object detection network 100 and association detection network 200 in turn, to finally output an output value of the association detection result for each sample matching object group. For the processing by the object detection network and the association detection network, reference may be made to the foregoing, which will not be repeated herein.

After the output value of the association detection result for each sample matching object group is obtained, the error between the output value and the label information may be determined, and the network parameter may be adjusted according to error back propagation until the error converges, thereby completing the training of the object detection network and the association detection network.

The method according to the present disclosure is described in detail with reference to the above examples. Those skilled in the art may understand that the method of detecting associated objects according to the present disclosure is not limited to the above example scenes, and may also be applied to association detection of any other target objects that may be associated with one another in the spatial position, which will not be illustrated herein.

As above, the method of detecting associated objects according to the present disclosure uses association features of target objects in a same matching object group to assist in target detection, to improve the accuracy of target detection in complex scenes. For example, human detection in multi-person scenes can be implemented through the face-and-body association detection, thereby improving detection accuracy. In addition, by combining the visual information and the spatial information of the target objects during association detection, the accuracy of the association detection of the target objects can be improved. For example, during the face-and-body association detection, not only visual feature information of the face and the body are used, but also spatial position feature information between the face and the body is further considered. Using the spatial position feature to assist in face-and-body association, it is possible to improve the accuracy of the face-and-body association, thereby improving the accuracy of target detection.

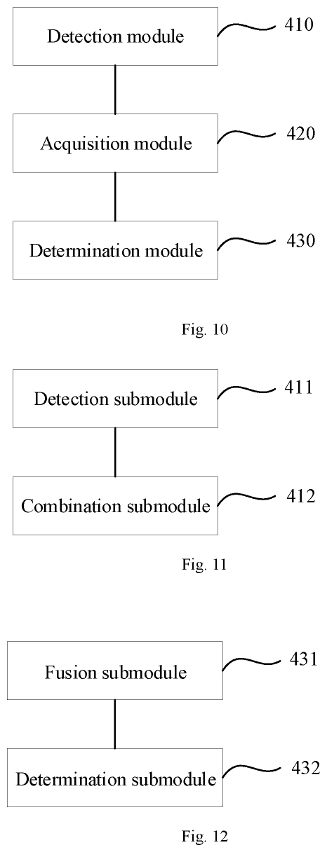

In a second aspect, embodiments of the present disclosure provide an apparatus for detecting associated objects. FIG. 10 shows the apparatus for detecting associated objects according to some embodiments of the present disclosure.

As shown in FIG. 10, in some embodiments, the apparatus according to the present disclosure includes:

a detection module 410, configured to detect at least one matching object group from an image to be detected, where each matching object group includes at least two target objects;

an acquisition module 420, configured to acquire visual information of each target object in each matching object group, and spatial information of the at least two target objects in each matching object group; and

a determination module 430, configured to determine whether the at least two target objects in each matching object group are associated, according to the visual information and the spatial information of the at least two target objects in each matching object group.

As shown in FIG. 11, in some embodiments, the detection module 410 may include:

a detection submodule 411, configured to detect each target object and an object category of each target object from the image to be detected; and

a combination submodule 412, configured to combine each target object of each object category with each target object of other object categories to obtain the at least one matching object group.

In some embodiments, the acquisition module 420 may be further configured to:

perform visual feature extraction on each target object in the matching object group to obtain the visual information of the target object.

In some embodiments, the acquisition module 420 may be further configured to:

detect a detection box for each target object from the image to be detected; and

generate the spatial information of the at least two target objects in each matching object group, according to position information of the detection boxes for the at least two target objects in the matching object group.

In some embodiments, the acquisition module 420 may be further configured to:

generate an auxiliary bounding box for each matching object group, where the auxiliary bounding box may cover the detection box for each target object in the matching object group;

determine position feature information of each target object in the matching object group, according to the auxiliary bounding box and the detection box for each target object;

and

fuse the position feature information of each target object in the same matching object group to obtain the spatial information of the at least two target objects in the matching object group.

In some embodiments, the auxiliary bounding box may be one of bounding boxes covering each target object in the matching object group which has a minimum area.

As shown in FIG. 12, in some embodiments, the determination module 430 may include:

a fusion submodule 431, configured to perform fusion processing on the visual information and the spatial information of the at least two target objects in each matching object group to obtain a fusion feature of each matching object group; and

a determination submodule 432, configured to perform association classification processing on the fusion feature of each matching object group to determine whether the at least two target objects in the matching object group are associated.

In some embodiments, the determination submodule 432 may be further configured to:

perform the association classification processing on the fusion feature of each matching object group to obtain an association score between the at least two target objects in each matching object group;

determine the matching object group with a highest association score as a target matching object group, for a plurality of matching object groups to which a same target object belongs; and

determine that the at least two target objects in the target matching object group are associated target objects.

In some embodiments, in the case that the target objects are human body parts, the determination module 430 may be further configured to:

determine whether respective human body parts in the same matching object group belong to the same human body.

As above, the apparatus for detecting associated objects according to the present disclosure uses association features of target objects in a same matching object group to assist in target detection, to improve the accuracy of target detection in complex scenes. For example, human detection in multi-person scenes can be implemented through the face-and-body association detection, thereby improving detection accuracy. In addition, by combining the visual information and the spatial information of the target objects during association detection, the accuracy of the association detection of the target objects can be improved. For example, during the face-and-body association detection, not only visual feature information of the face and the body are used, but also spatial position feature information between the face and the body is further considered. Using the spatial position feature to assist in face-and-body association, it is possible to improve the accuracy of the face-and-body association, thereby improving the accuracy of target detection.

In a third aspect, embodiments of the present disclosure provide an electronic device, including:

a processor; and

a memory communicatively connected with the processor and storing computer instructions readable by the processor, where the computer instructions, when read by the processor, cause the processor to perform the method of any one of the embodiments in the first aspect.

In a fourth aspect, embodiments of the present disclosure provide a storage medium storing computer-readable instructions, where the computer-readable instructions are configured to cause a computer to perform the method of any one of the embodiments in the first aspect.

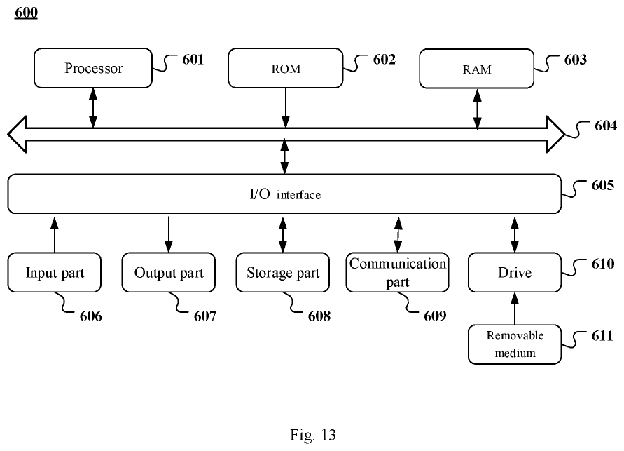

Specifically, FIG. 13 shows a schematic structural diagram of a computer system 600 suitable for implementing the method according to the present disclosure. The corresponding functions of the aforementioned processor and storage medium may be realized through the system shown in FIG. 13.

As shown in FIG. 13, the computer system 600 includes a processor (CPU) 601, which may be configured to perform various appropriate actions and processing according to a program stored in a Read-Only Memory (ROM) 602 or a program loaded from a storage part 608 into a Random Access Memory (RAM) 603. Various programs and data required for the operation of the system 600 may also be stored in the RAM 603. The CPU 601, the ROM 602, and the RAM 603 may be connected with each other through a bus 604. An input/output (I/O) interface 605 may also be connected to the bus 604.

The following components may be connected to the I/O interface 605: an input part 606 including a keyboard, a mouse, etc.; an output part 607 including a cathode ray tube (CRT), a liquid crystal display (LCD), etc., and a speaker, etc.; the storage part 608 including a hard disk, etc.; and a communication part 609 including a network interface card such as a LAN card, a modem, etc. The communication part 609 performs communication processing via a network such as an Internet. A drive 610 may also be connected to the I/O interface 605 as required. A removable medium 611, such as a magnetic disk, an optical disk, a magneto-optical disk, a semiconductor memory, etc., may be installed on the drive 610 as required, such that a computer program read therefrom may be installed in the storage part 608 as required.

In particular, according to the embodiments of the present disclosure, the above method may be implemented as a computer software program. For example, embodiments of the present disclosure include a computer program product, which includes a computer program tangibly embodied on a machine-readable medium, and the computer program includes program codes for performing the above method. In such embodiments, the computer program may be downloaded and installed from the network through the communication part 609, and/or be installed from the removable medium 611.

The flowcharts and block diagrams in the accompanying drawings illustrate architectures, functions, and operations of possible implementations of a system, method, and computer program product in accordance with various embodiments of the present disclosure. In this regard, each block in the flowchart or block diagram may represent a module, program segment, or part of the codes, and the module, program segment, or part of the codes contains one or more executable instructions for implementing a specified logic function. It should also be noted that, in some alternative implementations, the functions noted in the blocks may also occur in a different order from that noted in the drawings. For example, two blocks shown in succession may actually be performed substantially in parallel, and may sometimes be performed in a reverse order, depending on the functions involved. It should also be noted that each block in the block diagram and/or flowchart, and a combination of the blocks in the block diagram and/or flowchart, may be implemented with a dedicated hardware-based system that performs specified functions or operations, or may be implemented with a combination of dedicated hardware and computer instructions.

Obviously, the foregoing embodiments are merely examples provided for clear description, and are not intended to limit the embodiments. For those ordinary skilled in the art, other changes or variations in different forms may also be made on the basis of the above description. It is unnecessary and impossible to exhaustively list all embodiments herein. Obvious changes or variations derived therefrom still fall within the protection scope of the present disclosure.

1. A method of detecting associated objects, comprising:
detecting at least one matching object group from an image to be detected, wherein each of the at least one matching object group comprises at least two target objects;
for each of the at least one matching object group,
acquiring visual information of each of the at least two target objects in the matching object group and acquiring spatial information of the at least two target objects in the matching object group; and
determining whether the at least two target objects in the matching object group are associated, according to the visual information and the spatial information of the at least two target objects in the matching object group.

2. The method of claim 1, wherein detecting the at least one matching object group from the image to be detected comprises:
detecting each target object and a corresponding object category of the target object from the image to be detected; and
combining each target object in the corresponding object category with one or more other target objects in one or more other corresponding object categories to obtain the at least one matching object group.

3. The method of claim 1, wherein acquiring the visual information of each of the at least two target objects in the matching object group comprises:
performing visual feature extraction on the target object in the matching object group to obtain the visual information of the target object.

4. The method of claim 1, wherein acquiring the spatial information of the at least two target objects in the matching object group comprises:
detecting a respective detection box for each target object from the image to be detected; and
generating the spatial information of the at least two target objects in the matching object group, according to position information of respective detection boxes for the at least two target objects in the matching object group.

5. The method of claim 4, wherein generating the spatial information of the at least two target objects in the matching object group comprises:
generating an auxiliary bounding box for the matching object group, wherein the auxiliary bounding box covers the respective detection box for each target object in the matching object group;
determining position feature information of each target object in the matching object group, according to the auxiliary bounding box and the respective detection box for each target object; and
fusing the position feature information of each target object in the matching object group to obtain the spatial information of the at least two target objects in the matching object group.

6. The method of claim 5, wherein the auxiliary bounding box has a minimum area among bounding boxes covering each target object in the matching object group.

7. The method of claim 1, wherein determining whether the at least two target objects in the matching object group are associated comprises:
performing fusion processing on the visual information and the spatial information of the at least two target objects in the matching object group to obtain a fusion feature of the matching object group; and
performing association classification processing on the fusion feature of the matching object group to determine whether the at least two target objects in the matching object group are associated.

8. The method of claim 7, wherein performing the association classification processing on the fusion feature of the matching object group to determine whether the at least two target objects in the matching object group are associated comprises:
performing the association classification processing on the fusion feature of the matching object group to obtain an association score between the at least two target objects in the matching object group;
determining the association score of the matching object group is highest among a plurality of matching object groups to which at least one of the at least two target objects in the matching object group belongs; and
determining that the at least two target objects in the matching object group are associated target objects.

9. The method of claim 1, wherein the at least two target objects in the matching object group are human body parts, and
wherein determining whether the at least two target objects in the matching object group are associated comprises:
determining whether the human body parts in the matching object group belong to a same human body.

10. The method of claim 1, further comprising:
acquiring a sample image set comprising at least one sample image, wherein each of the at least one sample image comprises at least one sample matching object group and label information corresponding to the at least one sample matching object group, wherein each of the at least one sample matching object group comprises at least two sample target objects, and wherein the label information represents association results for respective sample target objects in the at least one sample matching object group;
processing the sample image through an association detection network to be trained to detect the at least one sample matching object group from the sample image;
processing the sample image through an object detection network to be trained to obtain visual information of each of the at least two sample target objects in each of the at least one sample matching object group, and processing the sample image through the association detection network to be trained to obtain spatial information of the at least two sample target objects in each of the at least one sample matching object group;
for each of the at least one sample matching object group, obtaining an association detection result for the sample matching object group through the association detection network to be trained according to the visual information and the spatial information of the at least two sample target objects in the sample matching object group; and
determining an error between the association detection result for each of the at least one sample matching object group and respective label information for the sample matching object group, and adjusting a network parameter of at least one of the association detection network or the object detection network according to the error until the error converges.

11. An electronic device, comprising:
at least one processor; and
one or more memories coupled to the at least one processor and storing programming instructions for execution by the at least one processor to perform operations comprising:
detecting at least one matching object group from an image to be detected, wherein each of the at least one matching object group comprises at least two target objects;
for each of the at least one matching object group,
acquiring visual information of each of the at least two target objects in the matching object group and acquiring spatial information of the at least two target objects in the matching object group; and
determining whether the at least two target objects in the matching object group are associated, according to the visual information and the spatial information of the at least two target objects in the matching object group.

12. The electronic device of claim 11, wherein detecting the at least one matching object group from the image to be detected comprises:
detecting each target object and a corresponding object category of the target object from the image to be detected; and
combining each target object in the corresponding object category with one or more other target objects in one or more other corresponding object categories to obtain the at least one matching object group.

13. The electronic device of claim 11, wherein acquiring the visual information of each of the at least two target objects in the matching object group comprises:
performing visual feature extraction on the target object in the matching object group to obtain the visual information of the target object.

14. The electronic device of claim 11, wherein acquiring the spatial information of the at least two target objects in the matching object group comprises:
detecting a respective detection box for each target object from the image to be detected; and
generating the spatial information of the at least two target objects in the matching object group, according to position information of respective detection boxes for the at least two target objects in the matching object group.

15. The electronic device of claim 14, wherein generating the spatial information of the at least two target objects in the matching object group comprises:
generating an auxiliary bounding box for the matching object group, wherein the auxiliary bounding box covers the respective detection box for each target object in the matching object group;
determining position feature information of each target object in the matching object group, according to the auxiliary bounding box and the respective detection box for each target object; and
fusing the position feature information of each target object in the matching object group to obtain the spatial information of the at least two target objects in the matching object group.

16. The electronic device of claim 11, wherein determining whether the at least two target objects in the matching object group are associated comprises:
performing fusion processing on the visual information and the spatial information of the at least two target objects in the matching object group to obtain a fusion feature of the matching object group; and
performing association classification processing on the fusion feature of the matching object group to determine whether the at least two target objects in the matching object group are associated.

17. The electronic device of claim 16, wherein performing the association classification processing on the fusion feature of the matching object group to determine whether the at least two target objects in the matching object group are associated comprises:
performing the association classification processing on the fusion feature of the matching object group to obtain an association score between the at least two target objects in the matching object group;
determining the association score of the matching object group is highest among a plurality of matching object groups to which at least one of the at least two target objects in the matching object group belongs; and
determining that the at least two target objects in the matching object group are associated target objects.

18. The electronic device of claim 11, wherein the at least two target objects in the matching object group are human body parts, and
wherein determining whether the at least two target objects in the matching object group are associated comprises:
determining whether the human body parts in the matching object group belong to a same human body.

19. The electronic device of claim 11, wherein the operations further comprise:
acquiring a sample image set comprising at least one sample image, wherein each of the at least one sample image comprises at least one sample matching object group and label information corresponding to the at least one sample matching object group, wherein each of the at least one sample matching object group comprises at least two sample target objects, and wherein the label information represents association results for respective sample target objects in the at least one sample matching object group;
processing the sample image through an association detection network to be trained to detect the at least one sample matching object group from the sample image;
processing the sample image through an object detection network to be trained to obtain visual information of each of the at least two sample target objects in each of the at least one sample matching object group, and processing the sample image through the association detection network to be trained to obtain spatial information of the at least two sample target objects in each of the at least one sample matching object group;
for each of the at least one sample matching object group, obtaining an association detection result for the sample matching object group through the association detection network to be trained according to the visual information and the spatial information of the at least two sample target objects in the sample matching object group; and
determining an error between the association detection result for each of the at least one sample matching object group and respective label information for the sample matching object group, and adjusting a network parameter of at least one of the association detection network or the object detection network according to the error until the error converges.

20. A non-transitory computer-readable storage medium coupled to at least one processor and storing programming instructions for execution by the at least one processor to perform operations comprising:
detecting at least one matching object group from an image to be detected, wherein each of the at least one matching object group comprises at least two target objects;
for each of the at least one matching object group,
acquiring visual information of each of the at least two target objects in the matching object group and acquiring spatial information of the at least two target objects in the matching object group; and
determining whether the at least two target objects in the matching object group are associated, according to the visual information and the spatial information of the at least two target objects in the matching object group.
